(19) United States
(12) Patent Application Publication
(10) Pub. No.: US 2024/0326250 A1
(43) Pub. Date: Oct. 3, 2024

(54) SYSTEM AND METHOD FOR MONITORING A HAZARD ZONE OF A ROBOT

(71) Applicant: SICK AG, Waldkirch (DE)

(72) Inventors: Christoph HOFMANN, Waldkirch (DE); Peter POKRANDT, Waldkirch (DE)

(21) Appl. No.: 18/602,748

(22) Filed: Mar. 12, 2024

(30) Foreign Application Priority Data
Mar. 29, 2023 (DE) 102023107973.5

(51) Int. Cl. B25J 9/16; B25J 5/00; B25J 19/02

(52) U.S. Cl. CPC B25J 9/1676; B25J 5/007; B25J 19/023

(57) ABSTRACT

A system for monitoring a hazard zone of a robot having at least one sensor having at least one spatial monitored zone for monitoring the hazard zone, and a control and evaluation unit, and a robot controller for controlling the movements of at least one hazardous part of the robot, wherein the robot controller and the control and evaluation unit are electronically connected to one another by means of at least one interface, wherein the sensor is configured to cyclically transmit 3D data of the monitored zone to the control and evaluation unit, wherein the sensor and the control and evaluation unit are further configured to generate at least one spatial protected zone in the monitored zone, wherein the control and evaluation unit is configured to localize persons in the monitored zone of the sensor with reference to the 3D data and to determine their distance from the hazardous part of the robot, wherein the control and evaluation unit is configured to arrange the spatial protected zone such that the spatial protected zone completely surrounds and includes the hazardous part of the robot and a surface of the protected zone forms an outer safety boundary, wherein the location of the safety boundary is fixable in dependence on a distance, on a direction of movement and/or a movement speed of the person with respect to the hazardous part of the robot, and wherein the robot controller is configured to freely move the hazardous part of the robot within the protected zone.

The present invention relates to a system for monitoring a hazard zone of a robot and to a method of monitoring a hazard zone of a robot.

The invention relates to the field of robot motion planning under runtime conditions or under real time conditions. Robot trajectories should be optimized with respect to time, energy consumption, wear, acceleration, speed, or momentum transfer to human body parts by means of path planning algorithms and algorithms on kinematics.

A distinction should in particular be made between two scenarios here. If a human is not present in a robot application, the path planning should take place without any criteria of safety engineering, that is without protection of a human. Purely economic optimization criteria can then come into effect However, this changes fundamentally when a human is present. This human should be able to be safely recognized by industrial peripheral sensor systems.

The technical specification ISO/TS 15066:2016 provides instructions for a collaborating robot operation in which a robot system and humans share the same workspace. In such an operation, the integrity of safety-related control systems are of particular importance, in particular when process parameters such as the speed and force are controlled.

The standards ISO 10218-1 and ISO 10218.2 on the safety of industrial robots form the basis and provide instructions on operating modes with collaborating robots.

An object of the invention comprises providing an improved system for monitoring a hazard zone of a robot having at least one sensor and having at least one spatial monitored zone. A further object of the invention is to expand a solution space for a productive and collaborative robot conduct.

The object is satisfied by a system for monitoring a hazard zone of a robot having at least one sensor having at least one spatial monitored zone for monitoring the hazard zone, and a control and evaluation unit, and a robot controller for controlling the movements of at least one hazardous part of the robot, wherein the robot controller and the control and evaluation unit are electronically connected to one another by means of at least one interface, wherein the sensor is configured to cyclically transmit at least 3D data of the monitored zone to the control and evaluation unit, wherein the sensor and the control and evaluation unit are further configured to generate at least one spatial protected zone in the monitored zone, wherein the control and evaluation unit is configured to localize persons in the monitored zone of the sensor with reference to the 3D data and to determine their distance from the hazardous part of the robot, wherein the control and evaluation unit is configured to arrange the spatial. protected zone such that the spatial protected zone completely surrounds and includes the hazardous part of the robot and a surface of the protected zone forms an outer safety boundary, wherein the location of the safety boundary is fixable in dependence on a distance, on a direction of movement and/or a movement speed of the person with respect to the hazardous part of the robot, and wherein the robot controller is configured to freely move the hazardous part of the robot within the protected zone.

The object is furthermore satisfied by a method of monitoring a hazard zone of a robot having at least one sensor having at least one spatial monitored zone for monitoring the hazard zone, and a control and evaluation unit, and a robot controller for controlling the movements of at least one hazardous part of the robot, wherein the robot controller and the control and evaluation unit are electronically connected to one another by means of at least one interface, wherein the sensor cyclically transmits 3D data of the monitored zone to the control and evaluation unit, wherein the sensor and the control and evaluation unit generate at least one spatial protected zone in the monitored zone, wherein the control and evaluation unit localizes persons in the monitored zone of the sensor with reference to the 3D data and determines their distance from the hazardous part of the robot, wherein the control and evaluation unit arranges the spatial. protected zone such that the spatial protected zone completely surrounds and includes the hazardous part of the robot and a surface of the protected zone forms an outer safety boundary, wherein the location of the safety boundary is fixed in dependence on a distance, on a direction of movement and/or a movement speed of the person with respect to the hazardous part of the robot, and wherein the robot controller freely moves the hazardous part of the robot within the protected zone.

The control and evaluation unit is configured to localize objects or persons in the field of view of the sensor with reference to the 3D data of the sensor and to determine their distance from the hazardous movable part of the robot.

One, or, for example, more sensors, in particular 3D sensors, are preferably safety certified. They detect 3D data of the monitored zone in real time and with synchronization information and deliver the data to the control and evaluation unit.

A causal and dynamic adaptation of conditions for the motion planning of the robot can be resolved as follows: The periphery of an application is furnished by the at least one sensor, for example by means of industrial safety sensors. This sensor detects the presence of a person, i.e. of a human. If a person is detected, conditions for the path planning are changed, if this is necessary, in a path planning program, for example.

In accordance with the invention, the work routines of the robot are also maintained for as long as possible on the presence of a person and a safe collaboration is made possible. The work routines are adapted causally and dynamically depending on whether and where a person is in the vicinity of the robot and was detected by means of the sensor or the peripheral sensor system.

There are different strategies for this purpose. They differ fundamentally in the spatial and time domains.

Crushing scenarios and shear scenarios between the person and the moving hazardous part of the robot first have to be eliminated in the spatial domain since the greatest injury severity originates from them. Finally, a ramming of the robot or of the hazardous part of the robot has to be avoided.

In the time domain, all the moving parts or hazardous parts of the robot can be decelerated or stopped to give the person or worker more time to remove or free himself from a potentially hazardous situation.

If the hazard is no longer present, provision is made, for example, that a restart of the movement of the robot takes place.

An avoidance of crushing by moving parts of the robot can take place as follows, for example. Provision is, for example, made to skillfully restrict the protected zone or the volume in which possible trajectories are calculated. If e.g. a person is present, an additional 3D buffer zone can be added to the existing protected zone. This 3D buffer zone additionally surrounds the protected zone. This 3D buffer zone contributes to the contacts or the touching between the hazardous part of the robot and the person not taking place at all since sufficient space is always provided to avoid crushing in all the possible trajectories within the protected zone.

The 3D buffer zones that can be added on a presence of a person can, for example, be coupled to anthropometric data—e.g. the thickness of a hand, the thickness of an arm, the thickness of a leg, etc. In this respect, extra buffer zones can also be considered that may result from the typical movement speed of human extremities. There are a plurality of standards for such anthropometric data that also make a distinction between the age and the ethnic origins of persons.

An avoidance of shear by moving parts of the robot can take place as follows, for example. The possible shearing of human extremities in robot joints can be prevented. Some joint angles of the robot can then be provided with restrictions that avoid any shear. In particular no acute angles should be permitted. Provision is made here that every robot axis can be given different restrictions.

A deceleration or stopping of the hazardous moving parts of the robot is provided, for example. Finally, the relative speed between the person and the robot can be causally regulated. Measures of the standards such as ISO 10218-2 or ISO/TS 15066:2016 on the method of so-called speed and separation monitoring are taken into account, for example. Contrary to the above-named methods, the restrictions are not made in the spatial domain (that is, for example, in the path), but rather in the time domain since namely deceleration or stopping takes place in a manner keeping to the path and the travel is started situatively provided that the hazard potential is no longer present.

A hierarchic organization of the hazard reducing measures is provided, for example. Provision is, for example, made that a control system or a rule engine is used that processes rules on which causal conditions determine which of the above-described hazard reduction measures can be used. If e.g. a person is still a long way away from the robot, less far-reaching methods can initially be used such as the concept of the mean reflected mass (MRM concept). If the person moves closer, hazardous shear angles can e.g. additionally be avoided and the speed of the hazardous parts can be reduced. The protected zone or the volume for possible situative path planning is practically not restricted for this purpose.

Crushing is finally only avoided and the robot restricted in its freedom of movement only when the person is in the direct vicinity of the robot. An evaluation can also take place of whether e.g. sufficient time remains for certain mechanism such as “obtuse joint angles” to be possible in the anticipated approach time of the human. If this is to be precluded, for example, the robot must be stopped.

The movement of the robot can be maintained for a considerably longer time through the above-described measures than would be possible on a stopping of the robot or on a deceleration of the robot in a manner keeping to the path. The production can thus also be maintained for so long in the presence of a person until a solution space or a protected zone permits a movement for new robot paths. Evasion maneuvers of the robot are therefore thus possible in the presence of a person. An ergonomic cooperation between persons and robots can also be ensured in this manner. A frequency of a hazardous state is also reduced. This in turn has an advantageous influence on the degree of the performance level of the overall safety application. If the person is not present, the full volume or the entire monitored zone can be used for the path planning; the same applies to other restrictions. Optimization can thus be carried out simply according to economic criteria. A new kind of safety related interaction between the person and the robot can be made possible by the above-described measures.

In accordance with the invention, the robot controller is configured to adapt the kinematics of the hazardous part of the robot in the protected zone in space and/or time.

In a further development of the invention, the control and evaluation unit is configured to cause at least the hazardous part of the robot to perform an evasive movement if the distance of the person from the hazardous part of the robot falls below predefined distance values.

In accordance with the further development of the invention, the control and evaluation unit is configured to redirect the hazardous part of the machine to maintain productivity of the work routine or of the robot.

In a further development of the invention, the control and evaluation unit is configured to cause at least the hazardous part of the robot to avoid a ramming with the person.

An avoidance of ramming of the moving parts of the robot can take place as follows, for example. In the publication STEINECKER et al. Mean Reflected Mass: A Physically Interpretable Metric for Safety Assessment and Posture Optimization in Human-Robot Interaction. In: 2022 International Conference on Robotics and Automation (ICRA). IEEE, 2022. p. 11209-11215, the reflected mass of the robot is introduced and described. The reflected mass, in addition to the contact geometry and the relative speed between the person and the robot, is one of the parameters that the greatest influence on the severity of the human injuries on a collision. The reflected mass depends on the robot configuration and can in particular be optimized with kinematically redundant robots. The metrics of the mean reflected mass (MRM) is independent of the direction of contact/movement and allows the evaluation and optimization of the robot posture with respect to safety. Unlike existing metrics, this can be interpreted physically, which means that they can be set into relation with biomechanical injury data for a realistic and model-independent safety analysis.

Provision is now made to provide such algorithms for a calculation of the mean reflected mass and to use it causally and in a context specific manner when a person has been detected by the sensor. In the absence of the person, these algorithms are not activated since this as a rule lowers the productivity or the cycle time in the application. What is interesting in this approach is that a considerably better decision can be made than the worst case scenario by the concept of the mean reflected mass.

In a further development of the invention, the control and evaluation unit is configured to identify individual body parts or extremities of the person and to determine their distance, direction of movement, and/or a speed movement with respect to the hazardous part of the robot.

An identification of the endangered body parts or extremities takes place, for example. A conclusion can be drawn from the application context, for example, as to which body parts could be hit in the presence of a human. Causal specifications or causal If-Then specifications are accordingly made for the motion planning algorithm, for example. If in particular a calibrated sensor having a measuring spatial monitored zone is used, a measurement and estimation of the human extremities or body parts can be made. This measurement can also be used for the plausibilization that the input parameters for the path planning calculation are correct or appropriate.

In a further development of the invention, the robot controller and/or the control and evaluation unit is/are configured to take account of biomechanical properties of the person or of individual extremities in the kinematics of the hazardous part of the robot.

Permanent or static contacts and time limited contacts are in particular distinguished.

There is a risk of crushing with the permanent contacts in the case of a collision between the person and the robot since a human body part can be caught between the robot and the application surface.

On the time limited or transient contacts, the risk is not as high since the person can still evade here since the person is, for example, only pushed to the side. Limitations are accordingly less restrictive here.

Biomechanical limit values are fixed in accordance with the standard DIN ISO/TS 15066 to prevent loads that are caused by the robot movement and provides potential for a slight injury to an operator in the case of a contact between the operator and the robot.

Pressure values from conservative estimates on sensations of pain determined in studies can be used to determine transient pressure limits and force limits. The transmitted energy resulting from the hypothetical contact between the robot and the human can subsequently be modeled, with a fully inelastic contact between the robot and the robot being assumed and the payload capacity of the robot and factors associated with the body part of the operator coming into contact can be considered. Once the transmitted energy has been determined, recommendations can be worked out for the speed limit with respect to the robot movement in the collaboration space. This is done to keep the transmitted energy at a level that is below the threshold of slight injuries in humans in the case of a contact between the robot and the operator in the collaboration space.

Biomechanical limit values in accordance with the standard DIN ISO/TS 1506, Table A.2, are defined as follows:

| | | | Quasi-static contact | | Transient contact | |
|---|---|---|---|---|---|---|
| | | | Maximum | | Maximum | Maximum |
| | | | permissible | Maximum | permissible | permissible |
| | | | pressure ^{a} | permissible | pressure | force multi- |
| | | | pₛ | force ^{b} | multiplier ^{c} | plier ^{c} |
| Body region | Specific body area | | N/cm² | N | P_{T} | P_{T} |
| Skull and fore- | 1 | Middle of forehead | 130 | 130 | not applicable | not applicable |
| head ^{d} | 2 | Temple | 110 | | not applicable | |
| Face ^{d} | 3 | Masticatory muscle | 110 | 65 | not applicable | not applicable |
| Neck | 4 | Neck muscle | 140 | 150 | 2 | 2 |
| | 5 | Seventh neck muscle | 210 | | 2 | |
| Back and | 6 | Shoulder joint | 160 | 210 | 2 | 2 |
| shoulders | 7 | Fifth lumbar vertebra | 210 | | 2 | |
| Chest | 8 | Sternum | 120 | 140 | 2 | 2 |
| | 9 | Pectoral muscle | 170 | | 2 | |
| Abdomen | 10 | Abdominal muscle | 140 | 110 | 2 | 2 |
| Pelvis | 11 | Pelvic bone | 210 | 180 | 2 | |
| Opper arms and | 12 | Deltoid muscle | 190 | 150 | 2 | |
| elbow joints | 13 | Homeras | 220 | | 2 | |
| Lower arms and | 14 | Radial bone | 190 | 160 | 2 | 2 |
| wrist joints | 15 | Forearm muscle | 180 | | 2 | |
| | 16 | Arm nerve | 180 | | 2 | |
| Hands and | 17 | Forefinger pad D | 300 | 140 | | 2 |
| fingers | 18 | Forefinger pad ND | 270 | | 2 | |
| | 19 | Forefinger end joint D | 280 | | 2 | |
| | 20 | Forefinger end joint ND | 220 | | | |
| | 21 | Thenar eminence | 200 | | 2 | |
| | 22 | Paim D | 260 | | 2 | |
| | 23 | Fam ND | 260 | | | |
| | 24 | Back of the hand D | 200 | | 2 | |
| | 25 | Back of the hand ND | 190 | | 2 | |
| Thighs | 26 | Thigh mascle | 250 | 220 | 2 | 2 |
| knees | 27 | Kneecap | 220 | | 2 | |
| Lower legs | 28 | Middle of shin | 220 | 130 | 2 | 2 |
| | 25 | Calf muscle | 210 | | | |

In a further development of the invention, the robot controller and/or the control and evaluation unit is/are configured to take account of biomechanical properties of the person or of individual extremities and to calculate permitted speeds of the hazardous part of the robot based on the biomechanical properties of the person or of individual extremities and to take them into account in the kinematics of the hazardous part of the robot.

Limit values from biomechanical properties can be converted in accordance with the further development into permitted maximum robot speeds provided that the body part, the contact scenario, and the so-called effective robot mass are known.

Examples for speed limit values calculated on the basis of the body model on a transient contact in accordance with the standard DIN ISO/TS 1506, Table A.5, are defined as followed:

| | Speed limit as a function of robot effective mass, | | | | | |
|---|---|---|---|---|---|---|
| | based on maximum pressure value with an area of 1 cm² | | | | | |
| Body region | 1 | 2 | 5 | 10 | 15 | 20 |
| Hand/finger | 2 400 | 2 200 | 2 000 | 2 000 | 2 000 | 1 900 |
| Lower arm | 2 200 | 1 800 | 1.500 | 1 400 | 1 400 | 1 300 |
| Upper arm | 2 400 | 1 900 | 1 500 | 1 400 | 1 300 | 1 300 |
| Abdomen | 2 900 | 2 100 | 1.400 | 1 000 | 870 | 780 |
| Pelvis | 2 700 | 1 900 | 1 300 | 930 | 800 | 720 |
| Upper leg | 2 000 | 1 400 | 920 | 670 | 560 | 500 |
| Lower leg | 1 700 | 1 200 | 800 | 580 | 490 | 440 |
| Shoulders | 1 700 | 1 200 | 790 | 590 | 500 | 450 |
| Chest | 1 500 | 1 100 | 700 | 520 | 440 | 400 |

In a further development of the invention, the sensor is a time of flight sensor, a laser scanner having a plurality of scan planes, a time of flight camera, a stereo camera, an FMCW LiDAR sensor, an event camera, a radar sensor, an ultrawideband radio sensor, or an infrared camera.

Such sensors are suitable to effectively monitor a spatial monitored zone.

Time of flight measurement systems make a distance measurement possible by determining the time difference between the transmission of the light and the return of the light reflected by the measurement object.

The time of flight sensor, for example, works according to a direct time of flight process (dTOF), according to which brief light pulses or light pulse groups are transmitted and the time up to the reception of a remission or reflection of the light pulses at an object is measured. The light signals are here formed by light pulses.

However, other time of flight processes are also possible, for example the phase process, according to which transmitted light is amplitude modulated and a phase shift between the transmitted light and the received light is determined, with the phase shift likewise being a measure for the time of flight (indirect time of flight process, iTOF).

Furthermore, a CW (continuous wave) process can be used, with a light signal being used which is constant in time. In this process, for example, the individual photon events are distributed via a gating signal into two counters and a phase is calculated from the ratio of the counts.

A 3D camera, for example, monitors a monitored zone by means of a plurality of detected distance values. A 3D camera has the advantage that a volume-like protected zone can be simply monitored.

A stereo camera, for example, monitors the monitored zone by means of a plurality of detected distance values. The distance values are determined on the basis of the two camera of the stereo camera that are installed at a basic spacing from one another. A stereo camera equally has the advantage that a volume-like protected zone can be monitored.

Distance values on the basis of the measured time of flight that are determined by an image sensor are determined by means of a time of flight camera. A time of flight camera equally has the advantage that a volume-like protected zone can be monitored.

For example, the sensor is formed as a frequency modulated continuous wave (FMCW) LiDAR sensor.

Unlike a LiDAR sensor based on a time of flight measurement of laser pulses, an FMCW LiDAR sensor does not transmit pulsed transmitted light beams into the monitored zone, but rather continuous transmitted light beams that have a predetermined frequency modulation, that is a time variation of the wavelength of the transmitted light during a measurement, that is a time-discrete scanning of a measurement point in the monitored zone. The measurement frequency is here typically in the range from 10 to 30 Hz. The frequency modulation can be formed, for example, as a periodic up and down modulation. Transmitted light reflected by measurement points in the monitored zone has, in comparison with irradiated transmitted light, a time offset corresponding to the time of light that depends on the distance of the measurement point from the sensor and is accompanied by a frequency shift due to the frequency modulation. Irradiated and reflected transmitted light are coherently superposed in the FMCW LiDAR sensor, with the distance of the measurement point from the sensor being able to be determined from the superposition signal. The measurement principle of coherent superposition inter alia has the advantage in comparison with pulsed or amplitude modulated incoherent LiDAR measurement principles of increased immunity with respect to extraneous light from, for example, other optical sensors/sensor systems or the sun. The spatial resolution is improved with respect to radio sensors having wavelengths in the range of millimeters, whereby geometrical properties of an person become measurable.

If a measurement point moves toward the sensor or away from the sensor at a radial speed, the reflected transmitted light additionally has a Doppler shift. An FMCW LiDAR sensor can determine this change of the transmitted light frequency and can determine the distance and the radial speed of a measurement point from it in a single measurement, that is in a single scan of a measurement point, while at least two measurements, that is two time spaced scans of the same measurement point are required for a determination of the radial speed with a LiDAR sensor based on a time of flight measurement of laser pulses.

Event cameras emit an asynchronous stream of events that are triggered by changes in the illumination situation. The pixels of an event camera react to occurring brightness changes independently of one another. Each pixel stores a reference value for the brightness and continuously compares it with the current brightness value. If the brightness difference exceeds a threshold value, the pixel resets its reference value and generates an event: a discrete packet that contains the pixel address and the time stamp. Events can also contain the polarity (increase or decrease) of a brightness change or an immediate measurement of the intensity of illumination.

The radar sensors, for example, form spatial monitored zones for the monitoring of the protected zone. The protected zones can have practically any desired geometries. For example, the protected zones starting from the radar sensor housing are conical or lobe-shaped for spatial protected zones. An opening angle of a protected zone amounts to +/−60°, for example. Smaller or larger opening angles are also provided. However, with a sensor having more than one reception antenna and/or transmission antenna, rectangular protected zones or parallelepiped-shaped protected zones can also be formed.

The or each radar sensor, for example, emits radar waves by the reception antenna in the frequency range from 40 GHz to 125 GHz. The frequency band of the radar sensor can here be smaller than the indicated frequency range.

The sensor is an ultrawideband radio sensor, for example. The ultrawideband radio sensor in particular forms an ultrawide band radio location system, with the frequency used being in the range from 3.1 GHz to 10.6 GHz, with the transmission energy amounting to a maximum of 0.5 mW per radio station.

An absolute bandwidth in an ultrawideband radio location system amounts to at least 500 MHz or a relative bandwidth amounts to at least 20% of the central frequency.

The range of such a radio location system amounts, for example, to 0 to 50 m. In this respect, the short time duration of the radio pulses is used for the localization.

The radio location system thus only transmits radio waves having a low energy.

The system can be used very flexibly and has no interference.

Safety systems used in safety engineering have to intrinsically work particularly reliably and inherently safely and must therefore satisfy high safety demands, for example the standard EN13849 for safety of machinery and the machinery standard EN61496 for electrosensitive protective equipment (ESPE).

To satisfy these safety standards, a series of measures have to be taken such as a safe electronic evaluation by redundant and/or diverse electronics or different functional monitoring processes, especially the monitoring of the contamination of optical components, including a front screen. A safety laser scanner in accordance with such standards is known, for example, from DE 43 40 756 A1.

The term “functionally safe” is to be understood in the sense of the standards named or of comparable standards; measures are therefore taken to control errors up to a specified safety level. The safe sensor and/or at least one unsafe sensor moreover generate unsafe data such as raw data, point clouds, or the like. Unsafe is the opposite of safe for unsafe devices, transmission paths, evaluations, and the like and accordingly said demands on failsafeness are not satisfied here.

In a further development of the invention, the robot controller is configured to evaluate a 3D model of the environment and to move the hazardous part of the robot within the protected zone starting from the 3D model.

In accordance with the further development, for example, there is a CAD model of the application from which it becomes clear which volume or which geometric protected zone can be used for a path planning. It should here naturally be avoided that the robot having the hazardous moving part of the robot travels into the infrastructure of the application such as desks, conveyor belts, walls, etc.

Corresponding infrastructures are accordingly considered as unpermitted zones that have to be avoided by the hazardous part of the robot.

In a further development of the invention, the robot controller and/or the control and evaluation unit is/are configured to take account of the volume of the person or the volume of individual extremities and to add additional 3D buffer zones based on the volume of the person or the volume of individual extremities, with the volumes of the person or the volume of individual extremities having the additional 3D buffer zones being considered in the kinematics of the hazardous part of the robot.

The 3D buffer zones that can be added on a presence of a person can, for example, be coupled to anthropometric data—e.g. the thickness of a hand, the thickness of an arm, the thickness of a leg, etc. In this respect, extra buffer zones can also be considered that may result from the typical movement speed of the human extremities. There are a plurality of standards for such anthropometric data that also make a distinction between the age and the ethnic origins of persons.

In a further development of the invention, the control and evaluation unit is configured to compare the received 3D data of the monitored zone with known position data of the environment and to check them for agreement.

In accordance with the further development, a static environment is taught. Dynamically moving objects such as persons can thus already be detected and tracked more simply.

In a further development of the invention, the robot is a mobile robot or a stationary robot.

The robot can, for example, be a multiaxial robot, for example an installation robot in a production line.

The invention will also be explained in the following with respect to further advantages and features with reference to the enclosed drawing and embodiments. The FIGURES of the drawing show in:

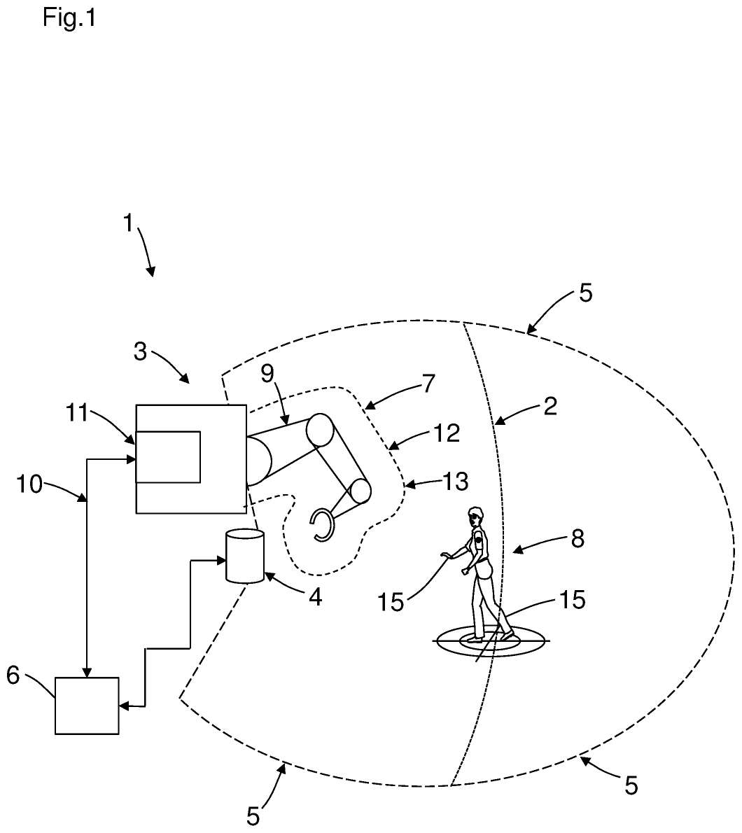

FIG. 1 a system for monitoring a hazard zone of a robot having at least one sensor.

In the following FIGURES, identical parts are provided with identical reference numerals.

FIG. 1 shows a system 1 for monitoring a hazard zone 2 of a robot 3 having at least one sensor 4 having at least one spatial monitored zone 5 for monitoring the hazard zone 3, and a control and evaluation unit 6, and a robot controller 11 for controlling the movements of at least one hazardous part 9 of the robot 3, wherein the robot controller 11 and the control and evaluation unit 6 are electronically connected to one another by means of at least one interface 10, wherein the sensor 4 is configured to cyclically transmit 3D data of the monitored zone 5 to the control and evaluation unit 6, wherein the sensor 4 and the control and evaluation unit 6 are further configured to generate at least one spatial protected zone 7 in the monitored zone 5, wherein the control and evaluation unit 6 is configured to localize persons 8 in the monitored zone 5 of the sensor 4 with reference to the 3D data and to determine their distance from the hazardous part 9 of the robot 3, wherein the control and evaluation unit 6 is configured to arrange the spatial protected zone 7 such that the spatial protected zone 7 completely surrounds and includes the hazardous part 9 of the robot 3 and a surface 12 of the protected zone 7 forms an outer safety boundary 13, wherein the location of the safety boundary 13 is fixable in dependence on a distance, on a direction of movement and/or a movement speed of the person 8 with respect to the hazardous part 9 of the robot 3, and wherein the robot controller 11 is configured to freely move the hazardous part 9 of the robot 3 within the protected zone 7.

For example, the sensor 4 is a time of flight sensor, a laser scanner having a plurality of scan planes, a time of flight camera, a stereo camera, an FMCW LiDAR sensor, a radar sensor, an ultrawideband radio sensor, or an infrared camera. Such sensors 4 are suitable to effectively monitor a spatial monitored zone 5.

The robot 3 is, for example, a mobile robot or a stationary robot. The robot 3 can, for example, be a multiaxial robot, for example an installation robot in a production line.

The control and evaluation unit 6 is configured to localize objects or persons 8 in the field of view of the sensor 4 with reference to the 3D data of the sensor 4 and to determine their distance from the hazardous movable part 9 of the robot 3.

This sensor 4 detects the presence of a person 8, i.e. of a human. If a person 8 is detected, conditions for the path planning are changed, if this is necessary, in a path planning program, for example.

In accordance with the invention, the work routines of the robot 3 are also maintained for as long as possible on the presence of a person 8 and a safe collaboration is made possible. The work routines are adapted causally and dynamically depending on whether and where a person 8 is in the vicinity of the robot 3 and was detected by means of the sensor 4 or the peripheral sensor system. There are different strategies for this purpose. They differ fundamentally in the spatial and time domains.

Crushing scenarios and shear scenarios between the person 8 and the moving hazardous part 9 of the robot 3 first have to be eliminated in the spatial domain since the greatest injury severity originates from them. Finally, a ramming of the robot 3 or of the hazardous part 9 of the robot 3 has to be avoided.

In the time domain, all the moving parts or hazardous parts of the robot 3 can be decelerated or stopped to give the person 8 or worker more time to remove or free himself from a potentially hazardous situation.

An avoidance of crushing by moving parts of the robot 3 can take place as follows, for example. Provision is, for example, made to skillfully restrict the protected zone 7 or the volume in which possible trajectories are calculated. If e.g. a person 8 is present, an additional 3D buffer zone can be added to the existing protected zone 7. This 3D buffer zone additionally surrounds the protected zone 7. This 3D buffer zone contributes to contacts or the touching between the hazardous part 9 of the robot 3 and the person 8 not taking place at all since sufficient space is always provided to avoid crushing in all the possible trajectories within the protected zone 7.

The 3D buffer zones that can be added on a presence of a person 8 can, for example, be coupled to anthropometric data—e.g. the thickness of a hand, the thickness of an arm, the thickness of a leg, etc. In this respect, extra buffer zones can also be considered that may result from the typical movement speed of the human extremities.

An avoidance of shear by the moving parts 9 of the robot 3 can take place as follows, for example. The possible shearing of human extremities in robot joints can be prevented. Some joint angles of the robot 3 can be provided with restrictions that avoid any shear. In particular no acute angles should be permitted. Provision is made here that every robot axis can be given different restrictions.

A deceleration or stopping of the hazardous moving parts 9 of the robot 3 is provided, for example. Finally, the relative speed between the person 8 and the robot 3 can be causally regulated. Contrary to the above-named methods, the restrictions are not made in the spatial domain (that is, for example, in the path), but rather in the time domain since namely deceleration or stopping takes place in a manner keeping to the path and the travel is started situatively provided that the hazard potential is no longer present.

A hierarchic organization of the hazard reducing measures is provided, for example. Provision is, for example, made that a control system or a rule engine is used that processes rules on which causal conditions determine which of the above-described hazard reduction measures can be used. If e.g. a person 8 is still a long way away from the robot 3, less far-reaching methods can initially be used such as the concept of the mean reflected mass (MRM concept). If the person 8 moves closer, hazardous shear angles can e.g. additionally be avoided and the speed of the hazardous parts 9 can be reduced. The protected zone 7 or the volume for possible situative path planning is practically not restricted for this purpose. Crushing is finally only avoided and the robot 3 restricted in its freedom of movement only when the person 8 is in the direct vicinity of the robot 3. An evaluation can also take place of whether e.g. sufficient time remains for certain mechanism such as “obtuse joint angles” to be possible in the anticipated approach time of the person 8. If this is to be precluded, for example, the robot 3 must be stopped.

The movement of the robot 3 can be maintained for a considerably longer time through the above-described measures than would be possible on a stopping of the robot 3 or on a deceleration of the robot 3 in a manner keeping to the path. The production can thus also be maintained for so long in the presence of a person 8 until a solution space or a protected zone 7 permits a movement for new robot paths. Evasion maneuvers of the robot 3 are therefore thus possible in the presence of a person 8. An ergonomic cooperation between persons 8 and robots 3 can also be ensured in this manner.

In accordance with the invention, the robot controller 11 is configured to adapt the kinematics of the hazardous part 9 of the robot 3 in the protected zone 7 in space and/or time.

In a further development of the invention, the control and evaluation unit 6 is configured to cause at least the hazardous part 9 of the robot 3 to perform an evasive movement if the distance of the person 8 from the hazardous part 9 of the robot 3 falls below predefined distance values.

For example, the control and evaluation unit 6 is configured to identify individual body parts or extremities 15 of the person 8 and to determine their distance, direction of movement, and/or a speed movement with respect to the hazardous part 9 of the robot 3.

An identification of the endangered body parts or extremities 15 takes place, for example. A conclusion can be drawn from the application context, for example, as to which body parts could be hit in the presence of a person 8. Causal specifications or causal If-Then specifications are accordingly made for the movement planning algorithm, for example. If in particular a calibrated sensor 4 having a measuring spatial monitored zone 5 is used, a measurement and estimation of the human extremities or body parts can be made. This measurement can also be used for the plausibilization that the input parameters for the path planning calculation are correct or appropriate.

For example, the robot controller 11 and/or the control and evaluation unit 6 is/are configured to take account of biomechanical properties of the person 8 or of individual extremities 15 in the kinematics of the hazardous part 9 of the robot 3. Permanent or static contacts and time limited contacts are in particular distinguished.

There is a risk of crushing with the permanent contacts in the case of a collision between the person 8 and the robot 3 since a human body part can be caught between the robot 3 and the application surface.

On the time limited or transient contacts, the risk is not as high since the person 8 can still evade here since the person 8 is, for example, only pushed to the side. Limitations are accordingly less restrictive here.

For example, the robot controller 11 and/or the control and evaluation unit 6 is/are configured to take account of biomechanical properties of the person 8 or of individual extremities 15 and to calculate permitted speeds of the hazardous part 9 of the robot 3 based on the biomechanical properties of the person 8 or of individual extremities 15 and to take this into account in the kinematics of the hazardous part 9 of the robot 3.

Limit values from biomechanical properties can be converted in accordance with the further development into permitted maximum robot speeds provided that the body part, the contact scenario, and the so-called effective robot mass are known.

For example, the robot controller 11 is configured to evaluate a 3D model of the environment and to move the hazardous part 9 of the robot 3 within the protected zone 7 starting from the 3D model.

For example, there is a CAD model of the application from which it becomes clear which volume or which geometric protected 7 zone can be used for a path planning. It should here naturally be avoided that the robot 3 having the hazardous moving part 9 of the robot 3 travels into the infrastructure of the application such as desks, conveyor belts, walls, etc. Corresponding infrastructures are accordingly considered as unpermitted zones that have to be avoided by the hazardous part 9 of the robot 3.

For example, the control and evaluation unit 6 is configured to compare the received 3D data of the monitored zone 5 with known position data of the environment and to check them for agreement.

A static environment is taught, for example. Dynamically moving objects such as persons 8 can thus already be detected and tracked more simply.

### REFERENCE NUMERALS

1 system
2 hazard zone
3 robot
4 sensor
5 spatial monitored zone
6 control and evaluation unit
7 protected zone
8 person
9 hazardous part of the robot
10 interface
11 robot controller
12 surface of the protected zone
13 safety boundary
15 extremities

1. A system for monitoring a hazard zone of a robot,
having at least one sensor having at least one spatial monitored zone for monitoring the hazard zone;
and a control and evaluation unit;
and a robot controller for controlling the movements of at least one hazardous part of the robot,
wherein the robot controller and the control and evaluation unit are electronically connected to one another by means of at least one interface;
wherein the sensor is configured to cyclically transmit at least 3D data of the monitored zone to the control and evaluation unit;
wherein the sensor and the control and evaluation unit are further configured to generate at least one spatial protected zone in the monitored zone;
wherein the control and evaluation unit is configured to localize persons in the monitored zone of the sensor with reference to the 3D data and to determine their distance from the hazardous part of the robot,
wherein the control and evaluation unit is configured to arrange the spatial protected zone such that the spatial protected zone completely surrounds and includes the hazardous part of the robot and a surface of the protected zone forms an outer safety boundary, with the location of the safety boundary being fixable in dependence on a distance, on a direction of movement and/or a movement speed of the person with respect to the hazardous part of the robot,
and with the robot controller being configured to freely move the hazardous part of the robot within the protected zone.

2. The system in accordance with claim 1, wherein the control and evaluation unit is configured to cause at least the hazardous part of the robot to perform an evasive movement if the distance of the person from the hazardous part of the robot falls below predefined distance values.

3. The system in accordance with claim 1, wherein the control and evaluation unit is configured to cause at least the hazardous part of the robot to avoid a ramming with the person.

4. The system in accordance with claim 1, wherein the control and evaluation unit is configured to identify individual extremities of the person and to determine their distance, direction of movement, and/or speed movement with respect to the hazardous part of the robot.

5. The system in accordance with claim 1, wherein the robot controller and/or the control and evaluation unit is/are configured to take account of biomechanical properties of the person or of individual extremities in the kinematics of the hazardous part of the robot.

6. The system in accordance with claim 1, wherein the robot controller and/or the control and evaluation unit is/are configured to take account of biomechanical properties of the person or of individual extremities and to calculate permitted speeds of the hazardous part of the robot based on the biomechanical properties of the person or of individual extremities and to take them into account in the kinematics of the hazardous part of the robot.

7. The system in accordance with claim 1, wherein the sensor is a time of flight sensor, a laser scanner having a plurality of scan planes, a time of flight camera, a stereo camera, an FMCW LiDAR sensor, a radar sensor, an ultrawideband radio sensor, or an infrared camera.

8. The system in accordance with claim 1, wherein the robot controller is configured to evaluate a 3D model of the environment and to move the hazardous part of the robot within the protected zone starting from the 3D model.

9. The system in accordance with claim 1, wherein the robot controller and/or the control and evaluation unit is/are configured to take account of the volume of the person or the volume of individual extremities and to add additional 3D buffer zones based on the volume of the person or the volume of individual extremities, with the volume of the person or the volume of individual extremities having the additional 3D buffer zones being considered in the kinematics of the hazardous part of the robot.

10. The system in accordance with claim 1, wherein the control and evaluation unit is configured to compare the received 3D data of the monitored zone with known position data of the environment and to check them for agreement.

11. The system in accordance with claim 1, wherein the robot is a mobile robot or a stationary robot.

12. A method of monitoring a hazard zone of a robot,
having at least one sensor having at least one spatial monitored zone for monitoring the hazard zone;
and a control and evaluation unit;
and a robot controller for controlling the movements of at least one hazardous part of the robot,
wherein the robot controller and the control and evaluation unit are electronically connected to one another by means of at least one interface;
wherein the sensor cyclically transmits at least 3D data of the monitored zone to the control and evaluation unit;
wherein the sensor and the control and evaluation unit generate at least one spatial protected zone in the monitored zone;
wherein the control and evaluation unit localizes persons in the monitored zone of the sensor with reference to the 3D data and determines their distance from the hazardous part of the robot,
wherein the control and evaluation unit arranges the spatial protected zone such that the spatial protected zone completely surrounds and includes the hazardous part of the robot and a surface of the protected zone forms an outer safety boundary, with the location of the safety boundary being fixable in dependence on a distance, on a direction of movement and/or a movement speed of the person with respect to the hazardous part of the robot,
and with the robot controller freely moving the hazardous part of the robot within the protected zone.
